(19) United States
(12) Patent Application Publication
(10) Pub. No.: US 2007/0064194 A1
(43) Pub. Date: Mar. 22, 2007

(54) Eyeglasses set with sunglass clip

(76) Inventor: Jong Kim, Los Angeles, CA (US)

Correspondence Address: PARK LAW FIRM, 3255 WILSHIRE BLVD, SUITE 1110, LOS ANGELES, CA, 90010, US

(21) Appl. No.: 11/232,713

(22) Filed: Sep. 22, 2005

(51) Int. Cl. G02C 9/00

(52) U.S. Cl. 351/47

(57) ABSTRACT

An eyeglasses set with sunglass clip includes first and second clear lenses, a clear-lens bridge, first and second darkened lenses, and a darkened-lens bridge. Each clear lens includes an outer surface, an inner surface, an outward edge portion, and an inward edge portion. The clear-lens bridge connects the inward edge portions of the first and second clear lenses, and includes front, rear, top, bottom surfaces, and first and second connecting end portions. Each darkened lens includes an outer surface, an inner surface, an outward edge portion, and an inward edge portion. The darkened-lens bridge connects the inward edge portions of the first and second darkened lenses, and includes two ring-type hooking devices for holding the inward end portion of the darkened lens. Each ring-type hooking device includes first and second ring, and a slit formed between the two rings, and provides a space for the clear-lens bridge in a assembled state.

### BACKGROUND OF THE INVENTION

The present invention relates to an eyeglasses set with sunglass clip. More particularly, the present invention relates to a sunglass clipped eyeglasses set enabling a darkened-lens bridge to be detachably carried on a clear-lens bridge.

Conventional eyeglasses with a sunglass clip show attachments around rims of the clip for its attachment to the base eyeglasses. Although such attachments provide convenience for dual usage without a separate sunglass set, the sunglass clip mechanism is known to have difficulty applying design concepts. Further, because the sunglass clip covering the base glasses is inevitably spaced apart from the base glasses, the user has to suffer dual reflection while using the sunglass clip, thus increasing fatigue of the user's eyes.

Another disadvantage of the conventional eyeglasses having a sunglass clip is that the sunglass clip is noticeable due to the attachments and the substantial gap between the base glasses and the darkened glasses. One of the least welcome factors of the conventional eyeglasses having a sunglass clip would be difficulty applying fashion design to such eyeglass product, because of limitation caused by attachments and separate product from the base glasses.

Also, the mechanical structure connecting the darkened lens to the bridge is very important in the strength and the manufacturing cost of the glasses. The traditional structure made the manufacturing difficult and costly.

A subsequent demand is to provide an eyeglass set with a sunglass clip that enables the above-mentioned improvements while maintaining convenience in attachments of the base and darkened sets of an eyeglass system.

### SUMMARY OF THE INVENTION

The present invention contrives to solve the disadvantages of the prior art.

An object of the invention is to provide an eyeglasses set with sunglass clip.

Another object of the invention is to provide an eyeglasses set with sunglass clip which enables easy and fashionable use of the sunglass and the base clear eyeglasses.

Still another object of the invention is to provide an eyeglasses set with sunglass clip which makes strong structure and cost down in manufacturing.

An eyeglasses set with sunglass clip includes first and second clear lenses, a clear-lens bridge, first and second darkened lenses, and a darkened-lens bridge.

Each of the first and second clear lenses includes an outer surface, an inner surface, an outward edge portion, and an inward edge portion.

The clear-lens bridge connects the inward edge portions of the first and second clear lenses, and includes front, rear, top, bottom surfaces, and first and second connecting end portions.

Each of the first and second darkened lenses includes an outer surface, an inner surface, an outward edge portion, and an inward edge portion.

The darkened-lens bridge connects the inward edge portions of the first and second darkened lenses, and includes two ring-type hooking devices for holding the inward end portion of the darkened lens.

The darkened-lens bridge is detachably and clickably locked onto the clear-lens bridge.

In the eyeglasses set, each ring-type hooking device includes a first ring, a second ring stacked and aligned vertically with the first ring, a slit formed between the first and second rings for accepting and fixing the inward end portion of the darkened lens, and a partially circular wall for connecting the part of the perimeter of the first and second rings.

The darkened-lens bridge further includes a center hole and two side holes. The center hole is for accepting the center portion of the front surface of the clear-lens bridge, and surrounded by a top plate, a bottom plate, and two side plates. The plates are substantially perpendicular to the plane defined by the lenses.

The two side holes is for accepting the first and second connecting end portions of the clear-lens bridge end portion. The two side holes are separated from the center hole by the two side plates of the center hole.

The top plate of the darkened-lens bridge includes an inner side and an outer side, and the bottom plate of the darkened-lens bridge includes an inner side and an outer side.

The darkened-lens bridge further includes a locking device for locking the clear-lens bridge between the top and bottom plates in place.

The locking device includes a first protrusion on the inner side of the top plate and a second protrusion on the inner side of the bottom plate.

The top plate of the darkened-lens bridge includes one or more elongated bumps, and the elongated bump is aligned substantially parallel to the front side of the darkened-lens bridge.

The clear lens includes a decorative lens and a corrective lens. The darkened lens is adapted to protect human eyes from visible or ultra-violet lights.

The clear lens is substantially identical to the darkened lens in the shape and size. The clear lens is substantially identical to the darkened lens in the surface curvature.

The darkened lens includes a polyamide material.

The eyeglasses set further includes two temples connected to the outward end portions of the clear lenses and a nose pads provided on the rear surface of the clear-lens bridge.

The nose pads includes a first pad, a second pad, a connecting plate for connecting the first and second pads, and a locking hole provided on the plate for locking the nose pads to the clear-lens bridge. The first and second pads are connected so as to form a saddle to mount the nose snuggly.

The clear-lens bridge includes a protrusion on the rear surface, and the protrusion is adapted to fit into the locking hole and lock the nose pads.

Each of the temples includes a joint for folding.

The ring-type hooking device provides a space for the clear-lens bridge connected to the clear lens.

The advantages of the present invention are: (1) the eyeglasses with sunglass clip is convenient to assemble and dessemble; (2) the eyeglasses with sunglass clip makes the mechanical structure strong; and (3) the eyeglasses with sunglass clip makes the cost down in manufacturing possible.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of an eyeglasses set with sunglass clip according to the present invention;

FIG. 2 is a cross-sectional view taken along line II-II in FIG. 1;

FIG. 3 is a cross-sectional view taken along line III-III in FIG. 1;

FIG. 4 is a perspective view showing construction of the present invention;

FIG. 5 is a cross-sectional view taken along line V-V in FIG. 4;

FIG. 6 is a perspective view showing attachment of a darkened lens pair to a clear lens pair;

FIG. 7 is a cross-sectional view taken along line VII-VII in FIG. 6;

FIG. 8 is a front view of the eyeglasses set according to the present invention;

FIG. 9 is a top plan view of a darkened-lens bridge according to the present invention; and

FIG. 10 is a front plan view of the darkened-lens bridge of FIG. 9.

### DETAILED DESCRIPTION OF THE INVENTION

An eyeglasses set with sunglass clip 10 includes first and second clear lenses 12, a clear-lens bridge 22, first and second darkened lenses 14, and a darkened-lens bridge 36.

Each of the first and second clear lenses 18, 20 includes an outer surface 82, an inner surface 81, an outward edge portion 83, and an inward edge portion 84.

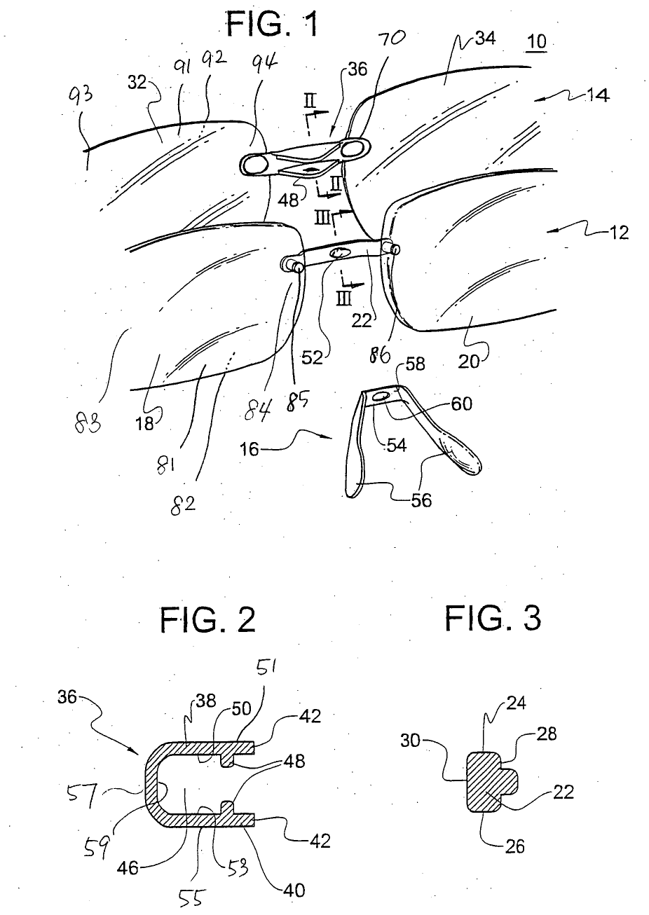

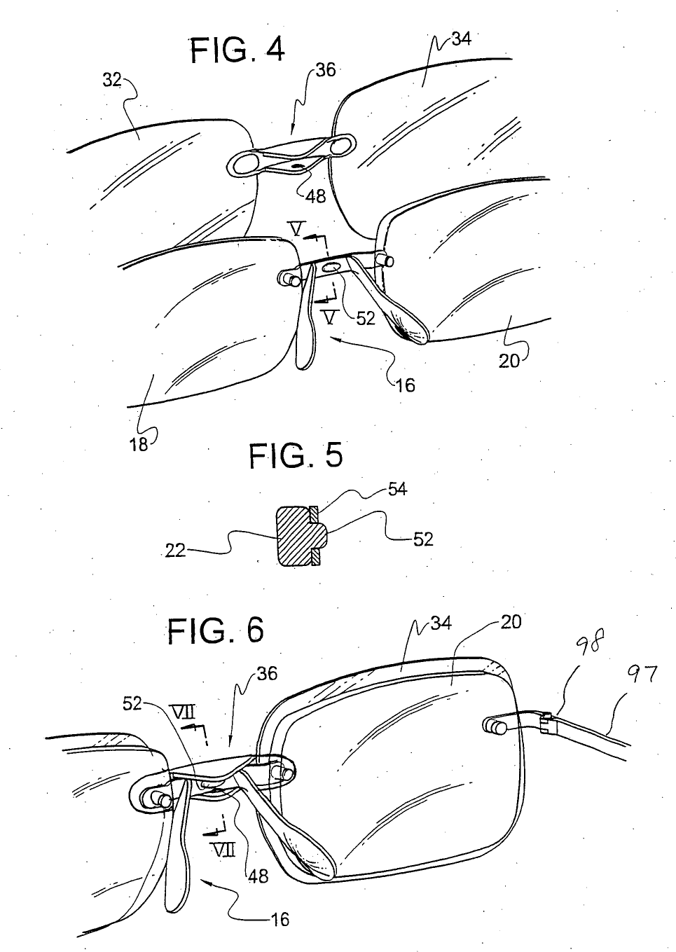

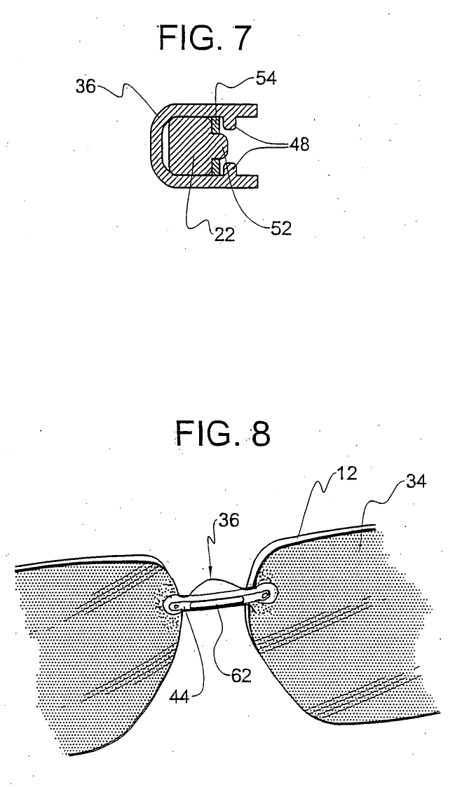

The clear-lens bridge 22 connects the inward edge portions 84 of the first and second clear lenses 18, 20, and includes front 30, rear 28, top 24, bottom 26 surfaces, and first and second connecting end portions 85, 86 as shown in FIG. 1 and FIG. 3.

Each of the first and second darkened lenses 32, 34 includes an outer surface 92, an inner surface 91, an outward edge portion 93, and an inward edge portion 94.

The darkened-lens bridge 36 connects the inward edge portions 94 of the first and second darkened lenses 32, 34, and includes two ring-type hooking devices 70 for holding the inward end portion 94 of the darkened lens 34.

The darkened-lens bridge 36 is detachably and clickably locked onto the clear-lens bridge 22.

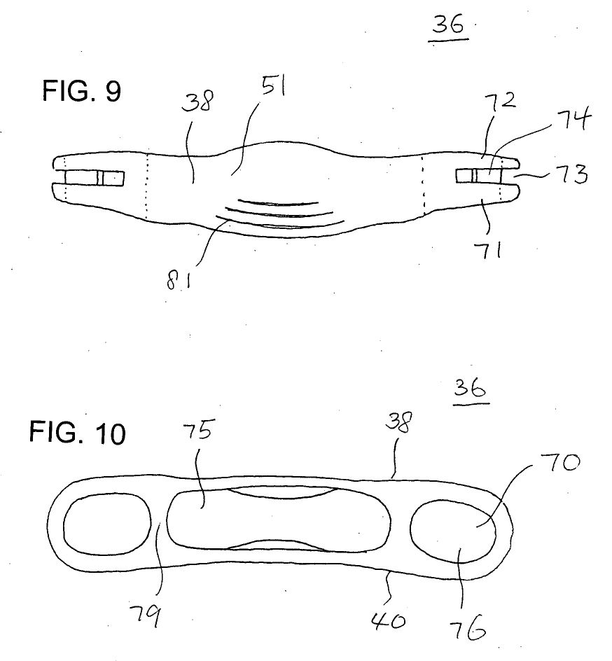

In the eyeglasses set 10, as shown in FIG. 2, FIG. 9, and FIG. 10, each ring-type hooking device 70 includes a first ring 71, a second ring 72 stacked and aligned vertically with the first ring 71, a slit 73 formed between the first and second rings 71, 72 for accepting and fixing the inward end portion 94 of the darkened lens 32, and a partially circular wall 74 for connecting the part of the perimeter of the first and second rings 71, 72.

The darkened-lens bridge 36 further includes a center hole 75 and two side holes 76. The center hole 75 is for accepting the center portion of the front surface 30 of the clear-lens bridge 22, and surrounded by a top plate 38, a bottom plate 40, and two side plates 79. The plates 38, 40, 79 are substantially perpendicular to the plane defined by the lenses 32, 34.

The two side holes 76 are for accepting the first and second connecting end portions 85, 86 of the clear-lens bridge 22. The two side holes 76 are separated from the center hole 75 by the two side plates 79 of the center hole 75.

The top plate 38 of the darkened-lens bridge 36 includes an inner side 50 and an outer side 51, and the bottom plate 40 of the darkened-lens bridge 36 includes an inner side 53 and an outer side 55.

The darkened-lens bridge 36 further includes a locking device 48 for locking the clear-lens bridge 22 between the top and bottom plates 38, 40 in place.

The locking device 48 includes a first protrusion on the inner side 50 of the top plate 38 and a second protrusion on the inner side 53 of the bottom plate 40.

The top plate 38 of the darkened-lens bridge 36 includes one or more elongated bumps 81, and the elongated bump 81 is aligned substantially parallel to the front side 57 of the darkened-lens bridge 36 as shown in FIG. 2 and FIG. 9.

The clear lens 18, 20 includes a decorative lens and a corrective lens. The darkened lens is adapted to protect human eyes from visible or ultra-violet lights.

The clear lens 18, 20 is substantially identical to the darkened lens in the shape and size. The clear lens 12 is substantially identical to the darkened lens 14 in the surface curvature.

The darkened lens 32, 34 includes a polyamide material.

The eyeglasses set 10 further includes two temples 97 connected to the outward end portions 83 of the clear lenses 18, 20 and a nose pads 16 provided on the rear surface 28 of the clear-lens bridge 22 as shown in FIG. 6.

The nose pads 16 includes first and second pad 56, a connecting plate 58 for connecting the first and second pads 56, and a locking hole 60 provided on the plate 58 for locking the nose pads 16 to the clear-lens bridge 22. The first and second pads 56 are connected so as to form a saddle to mount the nose snuggly.

The clear-lens bridge 22 includes a protrusion 52 on the rear surface 28, and the protrusion 52 is adapted to fit into the locking hole 60 and lock the nose pads 16.

Each of the temples 97 includes a joint 98 for folding.

The ring-type hooking device 70 provides a space for the clear-lens bridge 22 connected to the clear lens 18, 20.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An eyeglasses set with sunglass clip comprising:
a) first and second clear lenses, wherein each clear lens comprises an outer surface, an inner surface, an outward edge portion, and an inward edge portion;
b) a clear-lens bridge, connecting the inward edge portions of the first and second clear lenses, comprising front, rear, top, bottom surfaces, and first and second connecting end portions;
c) first and second darkened lenses, wherein each darkened lens comprises an outer surface, an inner surface, an outward edge portion, and an inward edge portion;
d) a darkened-lens bridge, connecting the inward edge portions of the first and second darkened lenses, comprising two ring-type hooking devices for holding the inward end portion of the darkened lens,
wherein the darkened-lens bridge is detachably and clickably locked onto the clear-lens bridge.

2. The eyeglasses set of claim 1, wherein each ring-type hooking device comprises:
a) a first ring;
b) a second ring stacked and aligned vertically with the first ring;
c) a slit formed between the first and second rings for accepting and fixing the inward end portion of the darkened lens; and
d) a partially circular wall for connecting the part of the perimeter of the first and second rings.

3. The eyeglasses set of claim 2, wherein the darkened-lens bridge further comprises:
a) a center hole for accepting the center portion of the front surface of the clear-lens bridge, surrounded by a top plate, a bottom plate, and two side plates, wherein the plates are substantially perpendicular to the plane defined by the lenses; and
b) two side holes for accepting the first and second connecting end portions of the clear-lens bridge end portion.

4. The eyeglasses set of claim 3, wherein the two side holes are separated from the center hole by the two side plates of the center hole.

5. The eyeglasses set of claim 2, wherein the top plate of the darkened-lens bridge comprises an inner side and an outer side, wherein the bottom plate of the darkened-lens bridge comprises an inner side and an outer side.

6. The eyeglasses set of claim 5, wherein the darkened-lens bridge further comprises a locking device for locking the clear-lens bridge between the top and bottom plates in place.

7. The eyeglasses set of claim 6, wherein the locking device comprises a first protrusion on the inner side of the top plate and a second protrusion on the inner side of the bottom plate.

8. The eyeglasses set of claim 2, wherein the top plate of the darkened-lens bridge comprises one or more elongated bumps, wherein the elongated bump is aligned substantially parallel to the front side of the darkened-lens bridge.

9. The eyeglasses set of claim 1, wherein the clear lens comprises a decorative lens and a corrective lens.

10. The eyeglasses set of claim 1, wherein the darkened lens is adapted to protect human eyes from visible or ultra-violet lights.

11. The eyeglasses set of claim 1, wherein the clear lens is substantially identical to the darkened lens in the shape and size.

12. The eyeglasses set of claim 1, wherein the clear lens is substantially identical to the darkened lens in the surface curvature.

13. The eyeglasses set of claim 1, wherein the darkened lens comprises a polyamide material.

14. The eyeglasses set of claim 1, further comprising:
a) two temples connected to the outward end portions of the clear lenses; and
b) a nose pads provided on the rear surface of the clear-lens bridge.

15. The eyeglasses set of claim 14, wherein the nose pads comprises:
a) a first pad;
b) a second pad;
c) a connecting plate for connecting the first and second pads; and
d) a locking hole provided on the plate for locking the nose pads to the clear-lens bridge,
wherein the first and second pads are connected so as to form a saddle to mount the nose snuggly.

16. The eyeglasses set of claim 15, wherein the clear-lens bridge comprises a protrusion on the rear surface, wherein the protrusion is adapted to fit into the locking hole and lock the nose pads.

17. The eyeglasses set of claim 14, wherein the temples comprises a joint for folding.

18. The eyeglasses set of claim 1, wherein the ring-type hooking device provides a space for the clear-lens bridge connected to the clear lens.
